(19) United States
(12) Patent Application Publication
(10) Pub. No.: US 2025/0220381 A1
(43) Pub. Date: Jul. 3, 2025

(54) RECONSTRUCTION OF INTERAURAL TIME DIFFERENCE USING A HEAD DIAMETER

(71) Applicant: HARMAN INTERNATIONAL INDUSTRIES, INCORPORATED, Stamford, CT (US)

(72) Inventor: Alfredo FERNANDEZ FRANCO, Los Angeles, CA (US)

(21) Appl. No.: 19/005,627

(22) Filed: Dec. 30, 2024

Related U.S. Application Data
(60) Provisional application No. 63/617,139, filed on Jan. 3, 2024.

(51) Int. Cl. H04S 7/00

(52) U.S. Cl. CPC H04S 7/302; H04S 2420/01

(57) ABSTRACT

Techniques for producing user-specific sound localization are described. In some embodiments, the techniques include: receiving head geometry information for a user, determining a calculated interaural-time-delay (ITD) value for the user based on the head geometry information, generating a first modified head-related transfer function (HRTF) with the calculated ITD value and a second modified HRTF with the calculated ITD value, generating a first modified audio signal with the first modified HRTF and a second modified audio signal with the second modified HRTF, and transmitting the first modified audio signal and the second modified audio signal to one or more loudspeakers.

### CROSS-REFERENCE TO RELATED APPLICATIONS

This application claims the benefit of U.S. Provisional patent application titled, “Reconstruction of Interaural Time Difference Using A Head Diameter Determined By A Camera-Based System,” filed on Jan. 3, 2024, and having Ser. No. 63/617, 139. The subject matter of this related application is hereby incorporated herein by reference.

### BACKGROUND

### Field of the Various Embodiments

This application relates to systems and methods for head and car tracking, and more specifically, to reconstruction of interaural time difference using a head diameter.

### Description of the Related Art

Headrest audio systems, seat or chair audio systems, sound bars, vehicle audio systems, and other personal and/or near-field audio systems are gaining popularity. However, the sound experienced by a user of a personal and/or near-field audio system can vary significantly (e.g., 3-6 dB or another value) when a listener moves their head, even very slightly. In the example of headrest audio systems, depending on how the user is positioned in a seat and how the headrest is adjusted, the variation from one person using the audio system to another person can also vary significantly. This level of sound pressure level (SPL) variability makes tuning audio systems difficult. Furthermore, when rendering spatial audio over headrest speakers, this variability causes features like crosstalk cancellation to fail.

One way of correcting audio for personal and/or near-field audio systems is the application of head-related transfer functions (HRTFs) to synthesize a binaural sound that seems to come from a particular point in space. Specifically, a pair of HRTFs (one for each ear of a listener) are applied to an audio signal to produce a desired sound localization. For example, various consumer entertainment systems have been designed to reproduce surround sound via stereo headphones headrest audio systems using HRTFs. Some forms of HRTF processing have also been included in computer software to simulate surround sound playback from loudspeakers.

A significant problem with conventional HRTF-based sound localization schemes is that generic HRTFs commonly employed in consumer devices rely on an embedded interaural time difference (ITD) value that is unlikely to match the actual ITD of a specific listener. With an incorrect ITD value, an HRTF incorrectly transforms an audio signal for that specific listener. As a result, conventional HRTF-based sound localization schemes often cannot synthesize finer gradations in perceived directionality of a sound. Instead, the perceived location of a sound produced using such a scheme may be limited to either directly to the front of the listener or directly to the side of the listener, resulting in a low-quality listener experience. In theory, listener-specific information, such as head geometry values, can be provided to a personal and/or near-field audio system to improve sound localization produced for a particular listener by that system. However, in the context of commercial audio products, relying on each new listener to accurately measure and input head size and/or ear location is generally unworkable.

As the foregoing illustrates, what is needed in the art is improved techniques for sound localization of virtual sound sources produced by audio systems.

### SUMMARY

One embodiment of the present disclosure sets forth a method that includes receiving head geometry information for a user, determining a calculated interaural-time-delay (ITD) value for the user based on the head geometry information, generating a first modified head-related transfer function (HRTF) with the calculated ITD value and a second modified HRTF with the calculated ITD value, generating a first modified audio signal with the first modified HRTF and a second modified audio signal with the second modified HRTF, and transmitting the first modified audio signal and the second modified audio signal to one or more loudspeakers.

At least one technical advantage of the disclosed techniques relative to the prior art is that, with the disclosed techniques, sound localization of a virtual sound source produced by an HRTF-based sound localization scheme is improved for any listener. The improved sound-localization provides a more three-dimensional audio listening experience to listeners for personal and/or near-field audio systems such as stereo headphones, headrest audio systems, seat/chair audio systems, sound bars, vehicle audio systems, and/or the like. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a schematic diagram illustrating an audio processing system, according to various embodiments;

FIG. 2 is a conceptual diagram of a user head and associated anthropomorphic landmarks, according to various embodiments;

FIG. 3 is a conceptual diagram of an HRTF filtering effect, according to various embodiments;

FIG. 4 conceptually illustrates a first impulse response associated with first sound propagation path and a second impulse response associated with second sound propagation path, according to an embodiment;

FIG. 5A conceptually illustrates the removal of an embedded inter-aural time delay that exists between a first impulse response and a second impulse response, according to an embodiment;

FIG. 5B conceptually illustrates the modification of the first impulse response and the second impulse response of FIG. 5A with a calculated inter-aural time delay, according to an embodiment;

FIG. 6A conceptually illustrates the removal of an embedded inter-aural time delay that exists between a first impulse response and a second impulse response, according to an embodiment;

FIG. 6B conceptually illustrates the modification of the first impulse response and the second impulse response of FIG. 6A with a calculated inter-aural time delay, according to an embodiment; and

FIG. 7 is a flow diagram of method steps for producing user-specific sound localization, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

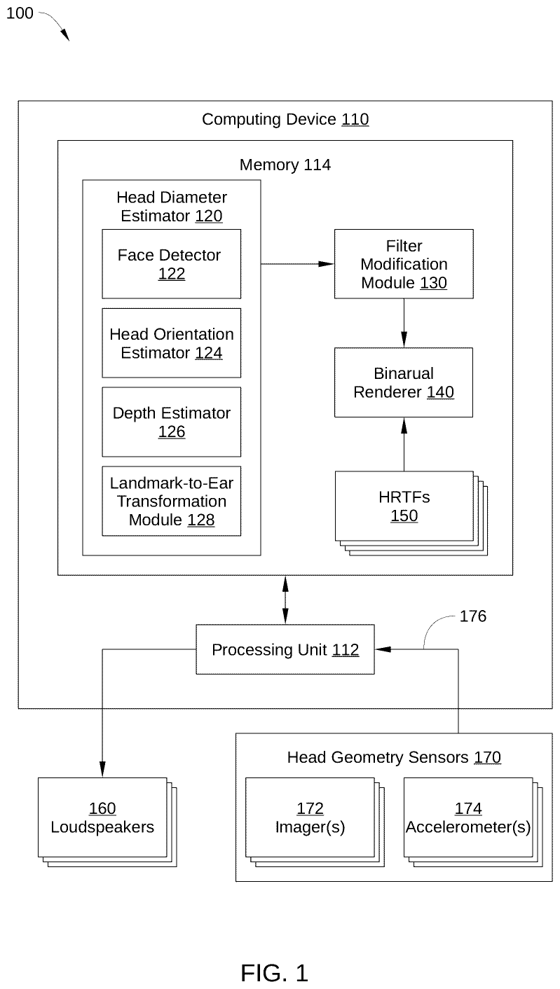

FIG. 1 is a schematic diagram illustrating an audio processing system 100, according to various embodiments. As shown, audio processing system 100 includes, without limitation, a computing device 110, one or more head geometry sensors 170, and one or more loudspeakers 160. Computing device 110 includes, without limitation, one or more processing units 112 and a memory 114. In various embodiments, an interconnect bus (not shown) connects processing unit 112, memory 114, and any other components of computing device 110. As shown, computing device 110 is communicatively coupled to loudspeakers 160 and head geometry sensors 170.

Memory 114 stores, without limitation, a head diameter estimator 120, a filter modification module 130, a binarual renderer 140 and a plurality of base head-related transfer functions (HRTFs) 150. In the embodiment illustrated in FIG. 1, head diameter estimator 120 includes, without limitation, a face detector 122, a head orientation estimator 124, a depth estimator 126, and a landmark-to-ear transformation module 128. While shown as components of head diameter estimator 120, face detector 122, head orientation estimator 124, depth estimator 126, and landmark-to-ear transformation module 128 can include executable instructions that work in concert with head diameter estimator 120 as subcomponents of and/or separate software modules from head diameter estimator 120. In some embodiments, one or more of the functions of head diameter estimator 120 (e.g., face detector 122, head orientation estimator 124, depth estimator 126, and/or landmark-to-ear transformation module 128) can be implemented by a properly trained neural network.

In various embodiments, computing device 110 is included in a vehicle system, a home theater system, a soundbar, stereo headphones, and/or the like. In some embodiments, computing device 110 is included in one or more devices, such as consumer products (e.g., portable speakers, gaming, etc. products), vehicles (e.g., the head unit of an automobile, truck, van, etc.), smart home devices (e.g., smart lighting systems, security systems, digital assistants, etc.), communications systems (e.g., conference call systems, video conferencing systems, speaker amplification systems, etc.), and the like. In various embodiments, computing device 110 is located in various environments including, without limitation, indoor environments (e.g., living room, conference room, conference hall, home office, etc.), and/or outdoor environments, (e.g., patio, rooftop, garden, etc.). Computing device 110 is also able to provide audio signals (e.g., generated using binaural renderer 140) to loudspeakers 160 to generate a sound field that provides various audio effects.

Processing unit 112 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of different processing units, such as a CPU configured to operate in conjunction with a GPU and/or a DSP. In general, processing unit 112 can be any technically feasible hardware unit capable of processing data and/or executing software applications.

Memory 114 can include a random-access memory (RAM) module, a flash memory unit, or any other type of memory unit or combination thereof. Processing unit 112 is configured to read data from and write data to the memory 114. In various embodiments, memory 114 includes non-volatile memory, such as optical drives, magnetic drives, flash drives, or other storage. In some embodiments, separate data stores, such as external data stores included in a network (“cloud storage”), can supplement memory 114. In some embodiments, memory 114 stores, without limitation, head diameter estimator 120, face detector 122, head orientation estimator 124, depth estimator 126, landmark-to-ear transformation module 128, filter modification module 130, binaural renderer 140 and HRTFs 150.

Loudspeakers 160 include various speakers for outputting audio to create the sound field or the various audio effects in the vicinity of the user. In some embodiments, loudspeakers 160 include two or more speakers located in a headrest of a seat such as a vehicle seat or a gaming chair, or another user-specific speaker set connected or positioned for use by a single user, such as a personal and/or near-field audio system. In some embodiments, loudspeakers 160 are associated with a speaker configuration stored in the memory 114. The speaker configuration indicates locations and/or orientations of loudspeakers 160 in a three-dimensional space and/or relative to one another and/or relative to a vehicle, a vehicle seat, a gaming chair, a location of imagers 172, and/or the like. In some embodiments, binaural renderer 140 can retrieve or otherwise identify the speaker configuration of loudspeakers 160.

Each loudspeaker 160 provides a sound output by reproducing a respective received audio signal. In some embodiments, loudspeakers 160 can be components of a wired or wireless speaker system, or any other device that generates a sound output. In some embodiments, loudspeakers 160 can be connected to output devices that additionally provide other forms of outputs, such as display devices that provide visual outputs. Each loudspeaker 160 of audio processing system 100 can be any technically feasible type of audio outputting device. For example, in some embodiments, each loudspeaker 160 includes one or more digital speakers that receive an audio signal in a digital form and convert the audio output signals into air-pressure variations or sound energy via a transducing process.

Head geometry sensors 170 generate head geometry information 176 for a user of audio processing system 100. In the embodiment illustrated in FIG. 1, head geometry sensors 170 include, without limitation, one or more imagers 172 and one or more accelerometers 174. In other embodiments, head geometry sensors can include any other sensors or devices capable of providing geometry information 176, such as a lidar (light detection and ranging) based device, an infrared-based device, and the like. Other types of sensors include, without limitation, motion sensors, pressure sensors, and so forth. In addition, in some embodiments, sensor(s) can include wireless sensors, including radio frequency (RF) sensors (e.g., radar), and/or ultrasonic sensors (e.g., sonar).

The one or more imagers 172 can include, without limitation, various types of cameras for capturing two-dimensional images of the user. In some embodiments, imagers 172 include a camera of a driver monitoring system (DMS) positioned within a vehicle or included in sound bar, a web camera, and/or the like. In some embodiments, imagers 172 include only a single standard two-dimensional imager without stereo or depth capabilities, while in other embodiments, imagers 172 include multiple cameras, such as a stereo imaging system.

The one or more accelerometers 174 can provide position and/or orientation information associated with a head of a user that can facilitate determination of a diameter of a user head by head diameter estimator 120. For example, in some embodiments, one or more accelerometers 174 can be disposed within a stereo headphone system worn by the user to provide inertial and/or orientational information associated with the head of the user. In some embodiments, accelerometers 174 can include, without limitation, an inertial measurement unit (IMU) (e.g., a three-axis accelerometer, gyroscopic sensor, and/or magnetometer).

Geometry information 176 includes, without limitation, information generated by head geometry sensors 170 that indicates the geometry of a head of a user. For example, in some embodiments geometry information 176 includes, without limitation, two-dimensional (2D) digital images of the head of a user, distance or range measurements associated with the head of the user, 3D contour information of the head of the user, and the like.

In operation, audio processing system 100 processes head geometry information 176 captured using one or more head geometry sensors 170 to estimate a head diameter for a user via head diameter estimator 120. The head diameter is provided to filter modification module 130 to calculate a more accurate interaural time difference (ITD) value for the user than that included in HRTFs 150 stored in memory 114. Filter modification module 130 can then generate modified HRTFs based on the calculated ITD value, and binaural renderer 140 applies the modified HRTFs to appropriately modify an audio signal that accurately synthesizes a binaural sound or other spatial/positional audio effects for the user. Thus, using the camera-based system, head diameter estimator 120 provides binaural renderer 140 with the information usable to reconstruct a corrected ITD without any user interaction, thereby improving the localization of virtual sources produced by audio system 100.

Head diameter estimator 120 determines a head diameter for a user of audio processing system 100, such as a listener wearing stereo headphones, a passenger in a vehicle equipped with headrest speakers, a gamer using a gaming chair, and/or the like. Head diameter estimator 120 can determine the head diameter using any technically feasible approach, including computer vision, 3D mapping, stereoscopic imaging, and the like. In the embodiments described below, head diameter estimator 120 determines the head diameter using the outputs of face detector 122, head orientation estimator 124, depth estimator 126, and landmark-to-ear transformation module 128. For example, in some embodiments, based on user-specific ear locations determined by landmark-to-ear transformation module 128, head diameter estimator 120 can determine a head diameter for the user. In other embodiments, head diameter estimator 120 determines the head diameter using any other suitable approach.

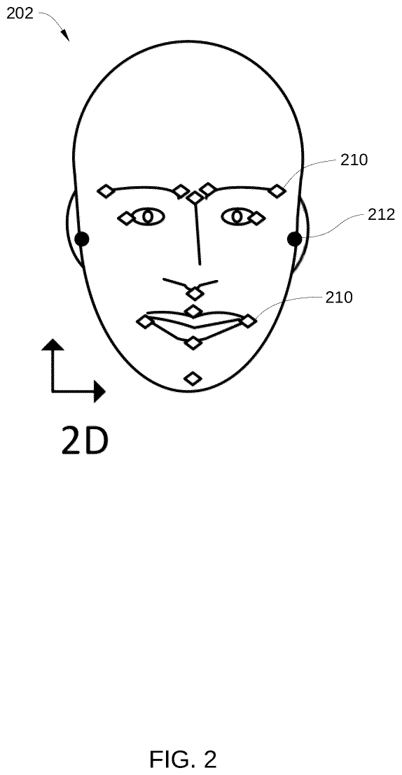

Face detector 122 of head diameter estimator 120 includes a machine-learning model, a rule-based model, or another type of model that receives head geometry information 176 as input and generates 2D landmarks. For example, in some embodiments, face detector 122 generates 2D landmark coordinates based on one or more 2D images included in head geometry information 176. The 2D landmark coordinates are 2D locations for one or more anthropomorphic landmarks associated with the head of the user. Embodiments of various 2D landmarks and landmark coordinates are described below in conjunction with FIG. 2.

FIG. 2 is a conceptual diagram of a user head 202 and associated anthropomorphic landmarks 210, according to various embodiments. As shown, face detector 122 localizes anthropomorphic landmarks 210 in 2D space, for example via computer vision or other image processing. Anthropomorphic landmarks 210 correspond to specific points, features, or locations on the face of the user and can include, without limitation, one or more eye landmarks (e.g., center, outer point, inner point, etc.), one or more eyebrow landmarks (e.g., outer point, inner point, midpoint, etc.), one or more nose landmarks (e.g., bridge, tip, base, root/radix, glabella, etc.), one or more mouth landmarks (e.g., left point, right point, upper midpoint, lower midpoint, etc.), one or more jawline landmarks (e.g., left point, right point, upper midpoint, lower midpoint, etc.), and two or more ear landmarks 212 (e.g., left ear canal, right ear canal, etc.), and/or the like. However, in some embodiments face detector 122 does not provide ear landmarks 212. Face detector 122 stores or otherwise provides 2D coordinates for anthropomorphic landmarks 210 to head orientation estimator 124 and/or depth estimator 126. In some embodiments, face detector 122 localizes anthropomorphic landmarks 210 in 3D space, for example when head geometry information 176 includes 3D information associated with user head 202.

Returning to FIG. 1, head orientation estimator 124 determines a head orientation, for example based on the 2D or 3D coordinates for anthropomorphic landmarks 210. In some embodiments, head orientation estimator 124 includes a rules-based module or program that detects or identifies a face orientation (e.g., centered and/or facing forward, facing upward, facing downward, facing left, facing right). In some embodiments, head orientation estimator 124 can analyze the 2D or 3D landmark coordinates and an appropriate head model to identify a head orientation or face orientation associated with the head of the user. In some embodiments, the head orientation of the head of the user is indicated by a 3D orientation vector that enables depth estimator 126 to more accurately identify landmark depth estimates.

Depth estimator 126 generates landmark depth estimates for respective ones and/or pairs of the 2D landmark coordinates 210 generated by face detector 122. A pair of 2D landmark coordinates can include a bridge-to-chin pair, a glabella-to-chin pair, a glabella-to-nasal-base pair, or another pair that is primarily vertical (e.g., having a greatest difference between the coordinates in a vertical dimension). A pair of 2D landmark coordinates can include an eye-to-eye pair, a jaw-to-jaw pair, or another pair that is primarily horizontal (e.g., greatest difference between the coordinates is in a horizontal dimension). However, any landmark pair can be used. Accuracy is increased for landmark pairs separated by a greater distance. As a result, the bridge-to-chin pair or the glabella-to-chin pair can provide greater accuracy in some embodiments. In some embodiments, depth estimator 126 uses one or more of the head orientation vector, 2D landmark coordinates, and head geometry information 176 to generate landmark depth estimates. In such embodiments, the landmark depth estimates can be considered a scaling factor that scales 3D landmark coordinates of anthropomorphic landmarks 210. In such embodiments, depth estimator 126 generates the landmark depth estimates based on a focal length of a camera that captured certain images included in head geometry information 176, the distance between a pair of 2D landmark coordinates, and the distance between a pair of two-dimensional landmark coordinates in a 2D image. In some embodiments, such distances in an image can be indicated in a number of pixels, and/or can be generated by multiplying the number of pixels by a physical width of each pixel. Alternatively, in some embodiments, depth estimator 126 generates landmark depth estimates for respective ones and/or pairs of the 2D landmark coordinates 210 based on 3D information included in head geometry information 176.

Landmark-to-ear transformation module 128 generates user-specific ear locations based on the 3D landmark coordinates determined by depth estimator 126, by extracting 3D location information for the cars of the user directly from head geometry information 176, or by reconstructing a 3D model of the head of the user (for example via computer vision or other image processing).

Each HRTF 150 is a direction-dependent filter that describes the acoustic filtering (modifications to a sound) by at least the head, torso, and outer ears (pinna) of a user and enables audio processing system 100 to perform binaural reproduction of an audio signal. In particular, HRTFs 150 provide cues to the user for the localization and externalization of virtual sound sources presented via loudspeakers 160, thereby synthesizing a binaural sound that the user perceives to originate from a particular point in space. With a plurality of direction-specific HRTFs 150, a virtual sound source from an arbitrary direction can be presented to the user via so called virtual auditory displays.

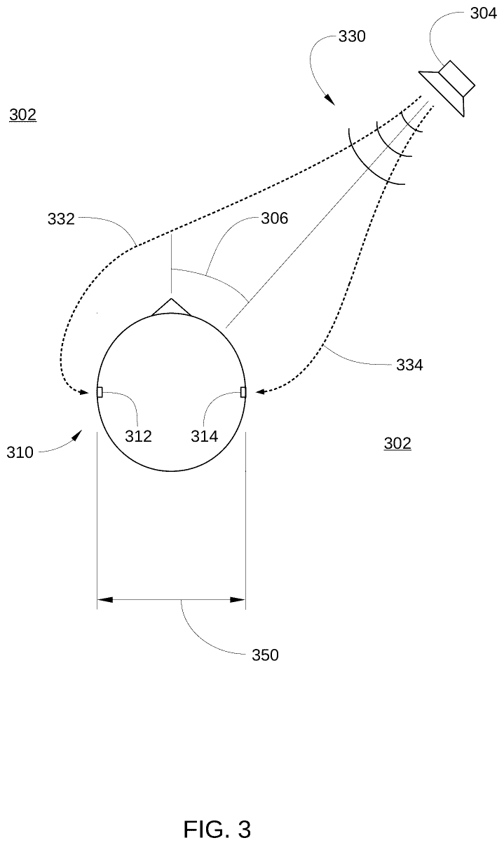

In operation, binaural pairs of HRTFs 150 are employed to enable the localization of a perceived sound source (for example, in the horizontal plane) via binaural renderer 140 and loudspeakers 160. Specifically, for a specific azimuthal direction, binaural renderer 140 employs a binaural pair of HRTFs that includes a first HRTF 150 for the left ear of the user and a second HRTF 150 for the right ear of the user. Thus, the first HRTF 150 approximates the filtering of a sound source before being perceived at the left ear of the user and the second HRTF 150 approximates the filtering of a sound source before being perceived at the right ear of the user. HRTFs 150 are well-known in the art and can be readily generated by one of skill in the art for a plurality of directions, for example in an anechoic chamber. HRTFs 150 are described in greater detail below in conjunction with FIG. 3.

FIG. 3 is a conceptual diagram of an HRTF filtering effect, according to various embodiments. As shown, a generic user head 310 is positioned in an anechoic chamber 302, in which a sound impulse 330 is produced by a sound source 304, where sound source 304 is positioned at a particular increment of azimuthal angle 306. In addition, microphones 312 and 314 are positioned at locations on generic user head 310 that approximate the locations of the cars of a user. Generic user head 310 has a diameter 350. Further, in some embodiments, generic user head 310 includes facial features, outer ears, and/or a torso to more accurately simulate the boosting and attenuating of various frequencies of sound impulse 330 at microphone 312 and microphone 314. For a particular azimuthal angle 306, a first HRTF 150 for a left ear of a user can be generated based on sound impulse 330 when received at microphone 312, and a second HRTF 150 for a right ear of a user can be generated based on sound impulse 330 when received at microphone 314.

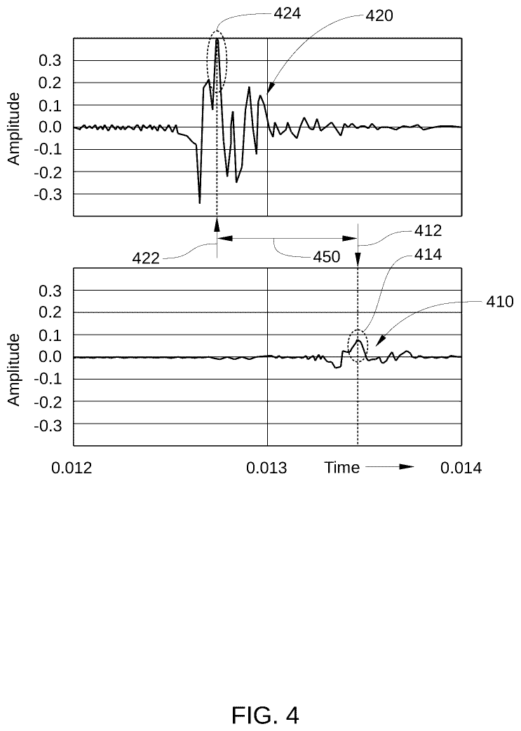

Sound impulse 330 follows a first sound propagation path 332 to microphone 312, which is on the left side of generic user head 310, and a second sound propagation path 334 to microphone 314, which is on the right side of generic user head 310. Because sound source 304 is positioned at an increment of azimuthal angle 306 that is not directly in front of or directly behind generic user head 310, first sound propagation path 332 is different than second sound propagation path 334. As a result, a time of arrival (TOA) of sound impulse 330 at first microphone 312 is different than the TOA of sound impulse 330 at second microphone 314. Thus, there is a non-zero ITD between the first HRTF 150 (generated for the left ear of the user) and the second HRTF 150 (generated for the left ear of the user). The ITD between the first HRTF 150 and the second HRTF 150 is described below in conjunction with FIG. 4.

FIG. 4 conceptually illustrates a first impulse response 410 associated with first sound propagation path 332 and a second impulse response 420 associated with second sound propagation path 334, according to an embodiment. First impulse response 410 is a head-related impulse response (HRIR) that is depicted in the time domain and thus shows changes in amplitude of a sound impulse (e.g., sound impulse 330 of FIG. 3) over time at microphone 312. It is noted that convolution of a particular sound impulse with first impulse response 410 converts that sound impulse to the sound heard by the left ear of the user. Similarly, second impulse response 420 is an HRIR that is depicted in the time domain showing changes in amplitude of a sound impulse over time at microphone 314. Therefore, convolution of a particular sound impulse with second impulse response 420 converts that sound impulse to the sound heard by the right ear of the user.

As shown, first impulse response 410 includes a first TOA 412, and second impulse response 420 includes a second TOA 422 that occurs before TOA 412. This is because microphone 314 (which is used to generate first impulse response 410) is closer to sound source 304 than microphone 312 (which is used to generate second impulse response 420). As a result, there is an ITD 450 between first impulse response 410 and second impulse response 420. In general, there is a different value for ITD 450 for each direction of a sound source from the user. In addition, the value of ITD 450 is a function of head diameter 350 of generic user head 310 (shown in FIG. 3).

In the embodiment illustrated in FIG. 4, first TOA 412 of first impulse response 410 corresponds to a maximum amplitude peak 414 of first impulse response 410 and second TOA 422 of second impulse response 420 corresponds to a maximum amplitude peak 424 of second impulse response 420. In other embodiments, first TOA 412 and second TOA 422 can be based on a center peak of the associated impulse response, a center of mass of the associated impulse response, or any other suitable feature of first TOA 412 and second TOA 422.

It is noted that the ability of the binaural pair of HRTFs 150 that are associated with first impulse response 410 and second impulse response 420 to accurately synthesize a binaural sound for a particular user depends on various user-specific factors. One such factor is how closely the HRTF 150 associated with first impulse response 410 matches the filtering characteristics of the left ear of that particular user and how closely the HRTF 150 associated with second impulse response 420 matches the filtering characteristics of the right ear of that particular user. Another factor is how close head diameter 350 matches the actual head diameter of that particular user. Because head diameter 350 is used to generate the binaural pair of HRTFs 150, and because head diameter 350 is unlikely to be identical to the head diameter of the particular user, the binaural pair of HRTFs 150 generally cannot be used to accurately synthesize a binaural sound for a given user. According to various embodiments, the binaural pair of HRTFs 150 are modified so that ITD 450 (which is based on generic user head 310) is replaced with a calculated ITD that is based on the user head diameter determined by head diameter estimator 120 of FIG. 1.

Returning to FIG. 1, filter modification module 130 determines a calculated ITD value for the user based on the head diameter determined for the user by head diameter estimator 120. There are various head-geometry models known in the art that parameterize ITD with respect to head diameter. Thus, given the head diameter determined for a particular user in real time by head diameter estimator 120, filter modification module 130 can calculate an ITD for the head of that particular user based on one or more such head-geometry models. In some embodiments, one such head-geometry model approximates the head as a sphere and assumes the cars are located 180 degrees apart from each other on the perimeter of the sphere. In other embodiments, a head-geometry model assumes a more complex shape for the head than a sphere, such as an ellipsoid, a spheroid, an oblate spheroid, a combination of multiple three-dimensional shapes, and/or the like. Further, in some embodiments, a head-geometry model assumes the cars are located at locations more closely approximating the actual positions of an average user head, such as at 95 and 275 degrees rather than at 90 degrees and 270 degrees. In yet other embodiments, a head-geometry model includes any other more advanced approximation of the user head shape than a simple sphere.

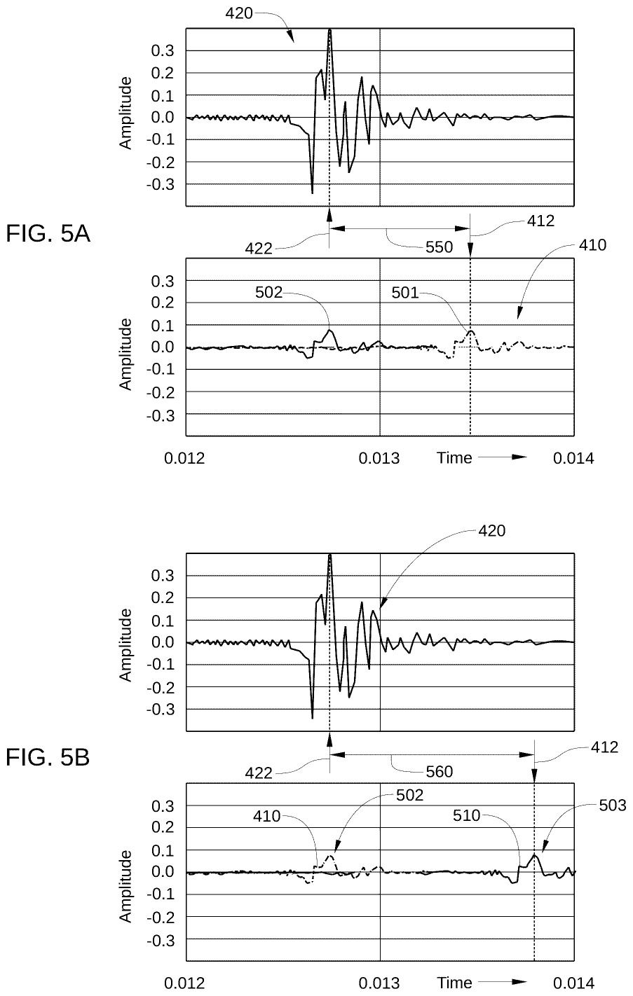

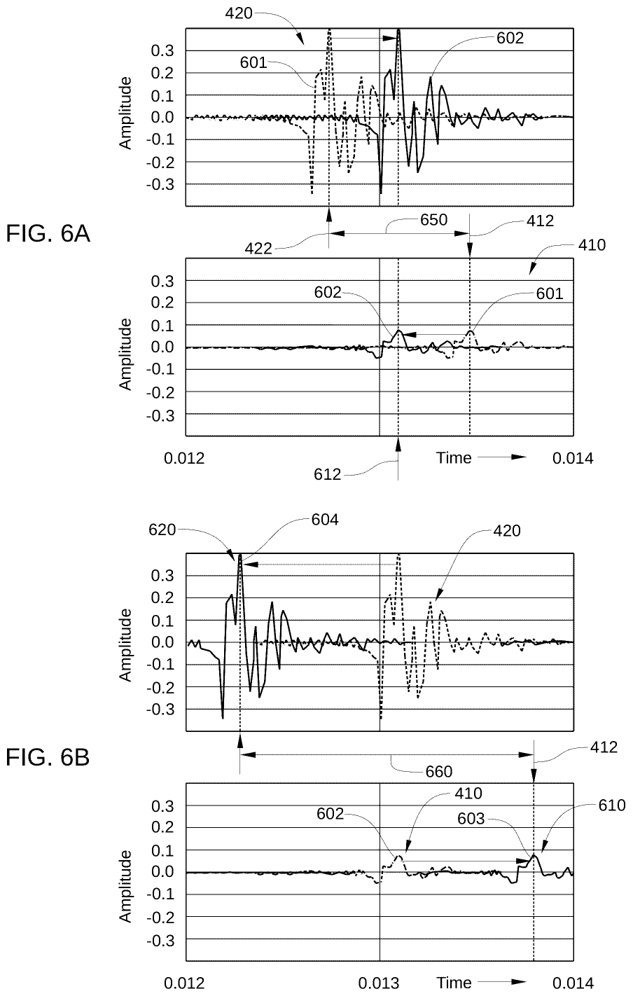

In addition, filter modification module 130 generates a pair of modified HRTFs based on the generic HRTFs 150 that are indicated to be used for synthesizing binaural sound for the current user. For example, based on the calculated ITD for the current user, filter modification module 130 generates a first modified HRTF for the left ear of the user and a second modified HRTF for the right ear of the user. According to various embodiments, filter modification module 130 modifies the binaural pair of generic HRTFs 150 by removing the embedded ITD that exists between the HRTF 150 for the user left ear and the HRTF 150 for the user right, then further modifies the pair of generic HRTFs 150 so that the calculated ITD is present therebetween. Embodiments of the modification of the binaural pair of generic HRTFs 150 is described in greater detail below in conjunction with FIGS. 5A-6B.

FIG. 5A conceptually illustrates the removal of an embedded ITD 550 that exists between first impulse response 410 and second impulse response 420, according to an embodiment. As shown, first impulse response 410 is modified so that first impulse response 410 is no longer offset in time from second impulse response 420 by embedded ITD 550. Specifically, in the embodiment illustrated in FIG. 5A, TOA 412 of first impulse response 410 is set equal to TOA 422 of second impulse response 420. Thus, first impulse response 410 is translated in the time domain from an original location 501 (dashed lines) to a modified location 502, so that first impulse response 410 is substantially aligned in time with second impulse response 420.

FIG. 5B conceptually illustrates the modification of first impulse response 410 and second impulse response 420 with a calculated ITD 560, according to an embodiment. As shown, first impulse response 410 (dashed lines) is modified to generate a modified first impulse response 510, where second impulse response 420 is offset in time from modified first impulse response 510 by calculated ITD 560. Specifically, in the embodiment illustrated in FIG. 5B, calculated ITD 560 is added to the TOA of second impulse response 420 (which is equal to TOA 412 in FIG. 5B). In this way, first impulse response 410 is converted to modified first impulse response 510, which is translated in the time domain from modified location 502 (dashed lines) to a final location 503. As a result, first impulse response 410 and second impulse response 420 are modified with respect to each other so that a user can experience a more accurate localization of the virtual sound source associated with first impulse response 410 and second impulse response 420.

In the embodiment described above in conjunction with FIGS. 5A and 5B, a single impulse response (e.g., first impulse response 410) of a binaural pair of impulse responses is adjusted in the time domain so that the ITD of the binaural pair equals a calculated ITD for a particular user. In other embodiments, both impulse responses of a binaural pair of impulse responses are adjusted in the time domain to achieve a similar effect for a particular user. One such embodiment is described below in conjunction with FIGS. 6A and 6B.

FIG. 6A conceptually illustrates the removal of an embedded ITD 650 that exists between first impulse response 410 and second impulse response 420, according to an embodiment. As shown, first impulse response 410 and second impulse response 420 are both modified so that first impulse response 410 is no longer offset in time from second impulse response 420 by embedded ITD 650. Specifically, in the embodiment illustrated in FIG. 6A, TOA 412 of first impulse response 410 is set equal to an average TOA 612 and TOA 422 of second impulse response 420 is also set equal to average TOA 612. Thus, first impulse response 410 and second impulse response 420 are both translated in the time domain from a respective original location 601 (dashed lines) to a modified location 602, so that second impulse response 420 is substantially aligned in time with first impulse response 410.

In the embodiment illustrated in FIG. 6A, the value of average TOA 612 is an average of the value of TOA 412 and the value of TOA 422. In other embodiments, the value of average TOA 612 can be any other suitable value that is based on the value of TOA 412 and the value of TOA 422, such as a weighted average, etc.

FIG. 6B conceptually illustrates the modification of first impulse response 410 and second impulse response 420 with a calculated ITD 660, according to an embodiment. As shown, first impulse response 410 (dashed lines) is modified to generate a modified first impulse response 610 and second impulse response 420 (dashed lines) is modified to generate a modified second impulse response 620. As a result, modified first impulse response 610 is offset in time from modified second impulse response 620 by calculated ITD 660. Specifically, in the embodiment illustrated in FIG. 6B, a portion of calculated ITD 660 is subtracted from the TOA of first impulse response 410 (which is equal to average TOA 612 in FIG. 6B) and a remainder portion of calculated ITD 660 is added to the TOA of second impulse response 420 (which is also equal to average TOA 612 in FIG. 6B). In this way, first impulse response 410 is converted to a modified first impulse response 610 disposed at a final location 603, which is offset in the time domain from modified location 602 (dashed lines) as shown. In addition, second impulse response 420 is converted to a modified second impulse response 620 disposed at a final location 604, which is offset in the time domain from modified location 602 (dashed lines) as shown. As a result, first impulse response 410 and second impulse response 420 are modified with respect to each other so that a user can experience a more accurate localization of the virtual sound source associated with first impulse response 410 and second impulse response 420.

Returning to FIG. 1, binaural renderer 140 is an audio application that generates modified audio signals for loudspeakers 160 and transmits the modified audio signals to loudspeakers 160 to produce localization of one or more virtual sound sources for a particular user. For example, in some embodiments, binaural renderer 140 generates a first modified audio signal for a first loudspeaker 160 using a first modified HRTF that is associated with a left ear of a user and a second modified audio signal for a second loudspeaker 160 using a second modified HRTF that is associated with a right ear of the user. According to various embodiments, the first modified HRTF and the second modified HRTF are based on a binaural pair of generic HRTFs 150 that are selected for a particular sound source position relative to a head of the user. In some embodiments, binaural renderer 140 uses head orientation data, speaker configuration data, and/or ear locations to generate a set of modified and/or processed audio signals based on an input audio signal. The set of modified and/or processed audio signals can produce a sound field and/or provide various adaptive audio effects such as noise cancellation, crosstalk cancellation, spatial/positional audio effects and/or the like, where the adaptive audio effects are rendered more accurately based on a real-time determination of the diameter of the head of the user. For example, in some embodiments, binaural renderer 140 identifies a binaural pair of HRTFs 150 based on ear locations, head orientation, speaker configuration, and the like. The binaural pair of HRTFs 150 are then modified by filter modification module 130, and binaural renderer 140 then modifies one or more speaker-specific audio signals based on the modified HRTFs to maintain a desired audio effect.

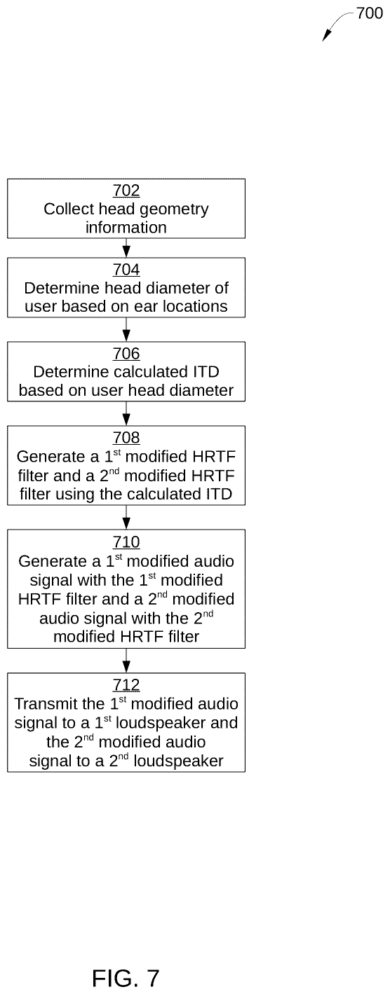

FIG. 7 is a flow diagram of method steps for producing user-specific sound localization, according to various embodiments. Although the method steps are shown in a specific order, persons skilled in the art will understand that some method steps may be performed in a different order, repeated, omitted, and/or performed by components other than those described in FIG. 7. Although the method steps are described with respect to the systems of FIGS. 1-6B, persons skilled in the art will understand that any system configured to perform the method steps, in any order, falls within the scope of the various embodiments.

As shown, a method 700 begins at step 702, where audio processing system 100 collects head geometry information for a particular user of audio processing system 100. For example, in an embodiment in which audio processing system 100 is implemented as a stereo headphone system, when the user dons the stereo headphone system, head geometry information is collected via one or more accelerometers 174, size-setting indicators, and/or pressure sensors included in the stereo headphone system and/or sensors (e.g., one or more imagers 712) external to the stereo headphone system. In another example, in embodiments in which audio processing system 100 is implemented as a headrest audio system, when the user occupies a seat associated with the headrest audio system, one or more head geometry sensors 170 (e.g., driver management system cameras) collect certain head geometry information, for example by capturing 2D image data and/or 3D contour data for the head of the user.

At step 704, head diameter estimator 120 determines the head diameter of the user based on the head geometry information collected in step 702. In some embodiments, head diameter estimator 120 determines the head diameter based on a 3D position of each ear of the user. For example, in some embodiments head diameter estimator 120 uses face detector 122, head orientation estimator 124, depth estimator 126, and/or landmark-to-ear transformation module 128 to process 2D images of the head of the user to determine the position of each ear of the user. In other embodiments, head diameter estimator 120 determines the position of each ear of the user using computer vision and/or 3D contour information to reconstruct a 3D position of each ear of the user. Additionally or alternatively, in some embodiments, head diameter estimator 120 determines the head diameter based on an orientation of the head of the user, for example as determined by head orientation estimator 124. Additionally or alternatively, in some embodiments, head diameter estimator 120 determines the head diameter based on one or more anthropomorphic landmarks on the head of the user, for example as determined by landmark-to-ear transformation module 128.

At step 706, filter modification module 130 determines a calculated ITD based on the user head diameter determined in step 704. In some embodiments, filter modification module 130 calculates an ITD for the head of the user based on one or more head-geometry models and the head diameter of the user.

At step 708, filter modification module 130 generates a pair of modified HRTFs based on the generic HRTFs 150 that are indicated to be used for synthesizing binaural sound for the current user. For example, in one embodiment, filter modification module 130 generates a first modified HRTF and a second modified HRTF using the calculated ITD from step 706. In some embodiments, filter modification module 130 generates the first modified HRTF by changing a first time-of-arrival value of a first HRTF 150 to a second time-of-arrival value, and generates the second modified HRTF by retaining a third time-of-arrival value of a second HRTF 150 at a same value, as described above in conjunction with FIGS. 5A and 5B. In such embodiments, a difference between the second time-of-arrival value and the third time-of-arrival value equals the calculated ITD value. In other embodiments, filter modification module 130 generates the first modified HRTF by changing a first time-of-arrival value of a first HRTF 150 to a second time-of-arrival value, and generates the second modified HRTF by changing a third time-of-arrival value of a second HRTF 150 to a fourth time-of-arrival value, as described above in conjunction with FIGS. 6A and 6B. In such embodiments, a difference between the second time-of-arrival value and the fourth time-of-arrival value equals the calculated ITD value.

At step 710, binaural renderer 140 generates a first modified audio signal for a first loudspeaker 160 and a second modified audio signal for a second loudspeaker 160 based on an audio input signal. For example, in some embodiments, the first modified audio signal is associated with a left ear of the current user and the second modified audio signal is associated with a right ear of the current user. In such embodiments, binaural renderer 140 generates the first modified audio signal with the first modified HRTF generated in step 708, which is associated with the left ear of the user. Similarly, binaural renderer 140 generates the second modified audio signal with the second modified HRTF generated in step 708, which is associated with the right ear of the user.

At step 712, binaural renderer 140 transmits the first modified audio signal to the first loudspeaker 160 and the second modified audio signal to the second loudspeaker 160. Method 700 then returns to step 702, where head geometry information is again collected by audio processing system 100.

In sum, techniques are disclosed for producing user-specific sound localization in an audio processing system. In some embodiments, various head geometry sensors are employed to estimate a diameter of a user head in real time. Based on the estimated diameter of the user head, a calculated ITD is determined and used to modify a binaural pair of HRTFs to be more accurately user-specific and thereby more accurately localize a virtual sound source perceived by the user. The modified binaural pair of HRTFs are then used to filter to an audio signal in order to generate a spatialized sound field.

At least one technical advantage of the disclosed techniques relative to the prior art is that, with the disclosed techniques, sound localization of a virtual sound source produced by an HRTF-based sound localization scheme is improved for any listener. The improved sound-localization provides a more three-dimensional audio listening experience to listeners for personal and/or near-field audio systems such as stereo headphones, headrest audio systems, seat/chair audio systems, sound bars, vehicle audio systems, and/or the like. This technical advantage represents one or more technological improvements over prior art approaches.

Aspects of the disclosure are also described according to the following clauses.

1. In some embodiments, a computer-implemented method includes: receiving head geometry information for a user; determining a calculated interaural-time-delay (ITD) value for the user based on the head geometry information; generating a first modified head-related transfer function (HRTF) with the calculated ITD value and a second modified HRTF with the calculated ITD value; generating a first modified audio signal with the first modified HRTF and a second modified audio signal with the second modified HRTF; and transmitting the first modified audio signal and the second modified audio signal to one or more loudspeakers for output.

2. The computer-implemented method of clause 1, wherein generating the first modified HRTF with the calculated ITD value comprises changing a first time-of-arrival value of a first HRTF to a second time-of-arrival value and generating the second modified HRTF with the calculated ITD value comprises changing a third time-of-arrival value of a second HRTF to a fourth time-of-arrival value based on the calculated ITD value.

3. The computer-implemented method of clauses 1 or 2, wherein a difference between the second time-of-arrival value and the fourth time-of-arrival value equals the calculated ITD value.

4. The computer-implemented method of any of clauses 1-3, wherein generating the first modified HRTF with the calculated ITD value comprises changing a first time-of-arrival value of a first HRTF to a second time-of-arrival value and generating the second modified HRTF with the calculated ITD value comprises retaining a third time-of-arrival value of a second HRTF at a same value.

5. The computer-implemented method of any of clauses 1-4, wherein a difference between the second time-of-arrival value and the third time-of-arrival value equals the calculated ITD value.

6. The computer-implemented method of any of clauses 1-5, further comprising determining a head diameter for the user based on the head geometry information.

7. The computer-implemented method of any of clauses 1-6, wherein determining the calculated ITD value for the user based on the head geometry information comprises determining the calculated ITD value for the user based on the head diameter.

8. The computer-implemented method of any of clauses 1-7, wherein determining the head diameter for the user based on the head geometry information comprises determining a three-dimensional position of each ear of the user.

9. The computer-implemented method of any of clauses 1-8, wherein determining the head diameter for the user based on the head geometry information comprises determining an orientation of a head of the user.

10. The computer-implemented method of any of clauses 1-9, wherein determining the head diameter for the user based on the head geometry information comprises identifying one or more anthropomorphic landmarks on a head of the user.

11. The computer-implemented method of any of clauses 1-10, wherein receiving the head geometry information for the user comprises at least one of acquiring one or more images of the user or receiving accelerometer information associated with movement of a head of the user.

12. In some embodiments, one or more non-transitory computer-readable media storing instructions that, when executed by one or more processors, cause the one or more processors to perform the steps of: receiving head geometry information for a user; determining a calculated interaural-time-delay (ITD) value for the user based on the head geometry information; generating a first modified head-related transfer function (HRTF) with the calculated ITD value and a second modified HRTF with the calculated ITD value; generating a first modified audio signal with the first modified HRTF and a second modified audio signal with the second modified HRTF; and transmitting the first modified audio signal and the second modified audio signal to one or more loudspeakers for output.

13. The one or more non-transitory computer-readable media of clause 12, wherein generating the first modified HRTF with the calculated ITD value comprises changing a first time-of-arrival value of a first HRTF to a second time-of-arrival value and generating the second modified HRTF with the calculated ITD value comprises changing a third time-of-arrival value of a second HRTF to a fourth time-of-arrival value based on the calculated ITD value.

14. The one or more non-transitory computer-readable media of clauses 12 or 13, wherein a difference between the second time-of-arrival value and the fourth time-of-arrival value equals the calculated ITD value.

15. The one or more non-transitory computer-readable media of any of clauses 12-14, wherein generating the first modified HRTF with the calculated ITD value comprises changing a first time-of-arrival value of a first HRTF to a second time-of-arrival value and generating the second modified HRTF with the calculated ITD value comprises retaining a third time-of-arrival value of a second HRTF at a same value.

16. The one or more non-transitory computer-readable media of any of clauses 12-15, wherein a difference between the second time-of-arrival value and the third time-of-arrival value equals the calculated ITD value.

17. The one or more non-transitory computer-readable media of any of clauses 12-16, further comprising determining a head diameter for the user based on the head geometry information.

18. The one or more non-transitory computer-readable media of any of clauses 12-17, wherein determining the calculated ITD value for the user based on the head geometry information comprises determining the calculated ITD value for the user based on the head diameter.

19. The one or more non-transitory computer-readable media of any of clauses 12-18, wherein receiving the head geometry information for the user comprises at least one of acquiring one or more images of the user or receiving accelerometer information associated with movement of a head of the user.

20. In some embodiments a system includes: one or more loud speakers; one or more head geometry sensors; a memory storing instructions; and one or more processors, that when executing the instructions, are configured to perform the steps of: receiving head geometry information for a user; determining a calculated interaural-time-delay (ITD) value for the user based on the head geometry information; generating a first modified head-related transfer function (HRTF) with the calculated ITD value and a second modified HRTF with the calculated ITD value; generating a first modified audio signal with the first modified HRTF and a second modified audio signal with the second modified HRTF; and transmitting the first modified audio signal and the second modified audio signal to the one or more loudspeakers for output.

21. The system of clause 20, wherein the one or more head geometry sensors comprise a camera.

22. The system of clause 20 or 21, wherein the one or more head geometry sensors comprise at least one of an accelerometer, an inertial measurement unit, a gyroscopic sensor, or a magnetometer.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
receiving head geometry information for a user;
determining a calculated interaural-time-delay (ITD) value for the user based on the head geometry information;
generating a first modified head-related transfer function (HRTF) with the calculated ITD value and a second modified HRTF with the calculated ITD value;
generating a first modified audio signal with the first modified HRTF and a second modified audio signal with the second modified HRTF; and
transmitting the first modified audio signal and the second modified audio signal to one or more loudspeakers for output.

2. The computer-implemented method of claim 1, wherein generating the first modified HRTF with the calculated ITD value comprises changing a first time-of-arrival value of a first HRTF to a second time-of-arrival value and generating the second modified HRTF with the calculated ITD value comprises changing a third time-of-arrival value of a second HRTF to a fourth time-of-arrival value based on the calculated ITD value.

3. The computer-implemented method of claim 2, wherein a difference between the second time-of-arrival value and the fourth time-of-arrival value equals the calculated ITD value.

4. The computer-implemented method of claim 1, wherein generating the first modified HRTF with the calculated ITD value comprises changing a first time-of-arrival value of a first HRTF to a second time-of-arrival value and generating the second modified HRTF with the calculated ITD value comprises retaining a third time-of-arrival value of a second HRTF at a same value.

5. The computer-implemented method of claim 4, wherein a difference between the second time-of-arrival value and the third time-of-arrival value equals the calculated ITD value.

6. The computer-implemented method of claim 1, further comprising determining a head diameter for the user based on the head geometry information.

7. The computer-implemented method of claim 6, wherein determining the calculated ITD value for the user based on the head geometry information comprises determining the calculated ITD value for the user based on the head diameter.

8. The computer-implemented method of claim 7, wherein determining the head diameter for the user based on the head geometry information comprises determining a three-dimensional position of each ear of the user.

9. The computer-implemented method of claim 7, wherein determining the head diameter for the user based on the head geometry information comprises determining an orientation of a head of the user.

10. The computer-implemented method of claim 7, wherein determining the head diameter for the user based on the head geometry information comprises identifying one or more anthropomorphic landmarks on a head of the user.

11. The computer-implemented method of claim 1, wherein receiving the head geometry information for the user comprises at least one of acquiring one or more images of the user or receiving accelerometer information associated with movement of a head of the user.

12. One or more non-transitory computer-readable media storing instructions that, when executed by one or more processors, cause the one or more processors to perform the steps of:
receiving head geometry information for a user;
determining a calculated interaural-time-delay (ITD) value for the user based on the head geometry information;
generating a first modified head-related transfer function (HRTF) with the calculated ITD value and a second modified HRTF with the calculated ITD value;
generating a first modified audio signal with the first modified HRTF and a second modified audio signal with the second modified HRTF; and
transmitting the first modified audio signal and the second modified audio signal to one or more loudspeakers for output.

13. The one or more non-transitory computer-readable media of claim 12, wherein generating the first modified HRTF with the calculated ITD value comprises changing a first time-of-arrival value of a first HRTF to a second time-of-arrival value and generating the second modified HRTF with the calculated ITD value comprises changing a third time-of-arrival value of a second HRTF to a fourth time-of-arrival value based on the calculated ITD value.

14. The one or more non-transitory computer-readable media of claim 13, wherein a difference between the second time-of-arrival value and the fourth time-of-arrival value equals the calculated ITD value.

15. The one or more non-transitory computer-readable media of claim 12, wherein generating the first modified HRTF with the calculated ITD value comprises changing a first time-of-arrival value of a first HRTF to a second time-of-arrival value and generating the second modified HRTF with the calculated ITD value comprises retaining a third time-of-arrival value of a second HRTF at a same value.

16. The one or more non-transitory computer-readable media of claim 15, wherein a difference between the second time-of-arrival value and the third time-of-arrival value equals the calculated ITD value.

17. The one or more non-transitory computer-readable media of claim 12, further comprising determining a head diameter for the user based on the head geometry information.

18. The one or more non-transitory computer-readable media of claim 17, wherein determining the calculated ITD value for the user based on the head geometry information comprises determining the calculated ITD value for the user based on the head diameter.

19. The one or more non-transitory computer-readable media of claim 12, wherein receiving the head geometry information for the user comprises at least one of acquiring one or more images of the user or receiving accelerometer information associated with movement of a head of the user.

20. A system comprising:
one or more loud speakers;
one or more head geometry sensors;
a memory storing instructions; and
one or more processors, that when executing the instructions, are configured to perform the steps of:
receiving head geometry information for a user;
determining a calculated interaural-time-delay (ITD) value for the user based on the head geometry information;
generating a first modified head-related transfer function (HRTF) with the calculated ITD value and a second modified HRTF with the calculated ITD value;
generating a first modified audio signal with the first modified HRTF and a second modified audio signal with the second modified HRTF; and
transmitting the first modified audio signal and the second modified audio signal to the one or more loudspeakers for output.
